(19) United States
(12) Patent Application Publication
(10) Pub. No.: US 2024/0392950 A1
(43) Pub. Date: Nov. 28, 2024

(54) COMPACT ADJUSTABLE LUMINAIRE

(71) Applicant: Luminii LLC, Niles, IL (US)

(72) Inventors: John Lloyd, Portsmouth, RI (US); Chris Gladden, Lakewood, CO (US)

(21) Appl. No.: 18/663,912

(22) Filed: May 14, 2024

Related U.S. Application Data
(60) Provisional application No. 63/468,271, filed on May 23, 2023.

(51) Int. Cl. F21V 13/06; F21V 14/04; F21V 21/15

(52) U.S. Cl. CPC F21V 13/06; F21V 14/04; F21V 21/15

(57) ABSTRACT

A luminaire module includes a light source located in a first plane and a truncated optical system having an optical axis. The truncated optical system is configured to focus and aim light from the light source to form an output beam. The module also controls a tilt angle of the output beam over a range of tilt angles by adjusting a position of the optical system relative to a position of the light source in a plane perpendicular to the optical axis. The spatial extent of the optical system is constrained to the minimum dimensions required in order to focus and aim substantially all of the light from the light source over a predetermined range of tilt angles for the output beam. A pan angle of the output beam can also be adjusted, such as by rotating the luminaire module. Tilt and/or pan may be manual or motorized and controlled by a control system. Multiple such luminaire modules may be combined.

### CROSS REFERENCE TO RELATED APPLICATIONS

This patent application claims priority to co-pending U.S. Provisional Application Ser. No. 63/468,271 filed May 23, 2023 entitled “Compact Adjustable Luminaire” the entire contents of which are hereby incorporated by reference.

### TECHNICAL FIELD

This patent application relates to lighting, specifically to the design of directional lighting products.

### BACKGROUND

Light sources for illumination purposes, such as light emitting diodes (LEDs), incandescent or halogen lamps, emit visible radiation in a broad range of angles. In lighting applications for many purposes this broad distribution of light is undesirable and directional light is needed. Lighting fixtures that collimate and direct illumination in specific directions are highly advantageous.

This task is typically accomplished with luminaires utilizing a light engine (including a light emitting source, circuitry to provide power, and often a heat sink to dissipate waste heat) and an optical system including one or more reflective or refractive optics to collimate, shape, and mix the light output into a desirable light distribution. The light engine and optics are typically fixed in position relative to each other, and the entire assembly is then tilted by various mechanical means in order to direct the light beam. The combined size and mass of the optical system along with the light engine presents numerous challenges, including placing directional lights in confined spaces or in close proximity to each other. In addition, the aesthetic impact of a multitude of directional lights aimed in different directions is often considered unappealing.

A known alternative to these traditional adjustable luminaires is to exploit imaging optics to collimate and aim a bright source. Systems utilizing this design have been shown in prior art using backward-firing light sources (aimed into the luminaire) coupled with reflective lenses. Beam steering is achieved by controlling in-plane displacement of the light source relative to the optical axis of the lens. Non-steering implementations of this type of optical system design are also valuable.

FIG. 1 shows an example back-firing optical system of the prior art as such as described in U.S. Patent Publication 2022/01196224A1, comprising a light emitting source 100 (such as an undomed LED), an optical system 180 comprising a solid optic (or “lens”) 104 made of transparent material with refractive index>1, and a first-surface-reflector (FSR) part 220 disposed in close proximity to the lens. A highly reflective surface layer 225 is present on the optical face 222 of the FSR 220. The FSR 220 may be separated from the rear face 106 of the solid optic 104 by a small air gap 230. The optical face 222 of the FSR part 220 features an overall curvature that conforms to the overall curvature of the rear face 106, so that the air gap 230 is approximately constant in thickness across the surface of the lens. Therefore, the reflector may be considered to be a conformal reflector. The light source 100 is supported on a support structure 110 that provides electrical connection to the light source 100 and conducts heat away from the light source 100. The support structure 110 may, for example, be a portion of a metal-core printed circuit board. It necessarily obscures a portion of the front face 102 of the optic 104, and may be shaped in various ways to minimize this obscuration.

Most light 101 from the light source 100 enters the front face 102 of the solid optic 104, transits the interior 103, exits the rear face 106, traverses the air gap 230, reflects off the optical face 222 of the FSR part, crosses the air gap 230 once again, enters the rear face of the optic 106, re-crosses the optic interior 103, and then exits the optic front face 102 in order to form the output beam 108. The direction of the output beam 108 may be controlled by adjusting the position of the light source 100 relative to the optical axis 105 of the solid optic 104, within the plane perpendicular to the optical axis 105.

The optical system 180 of prior art shown in FIG. 1 is characterized as “under-filled,” meaning that in any configuration the large majority of light from the light source 100 occupies only a portion of the optic, as shown by light rays 101. The portion of the optic that is used for this light path depends on the position of the light source 100 relative to the optical axis 105 of the solid optic 104. The lateral extent of the optical system 180 may be determined by the range of output beam directions that the optical system is designed to accommodate.

As described in the prior art, texturing may be applied to the rear face of the lens 106 and/or the optical face 222 of the FSR, in order to mix the light from the light source and create a desired beam shape. In some embodiments, the FSR may be adjustably rotated relative to the lens in order to control the width of the output beam 108.

Variants on this design are described in other prior art. For example, the separate FSR part 220 may be eliminated and replaced with a reflective coating placed directly on the rear face 106 of the optic 104.

These prior-art designs allow beams to be adjustably aimed from luminaires that are mounted stationary, via controlling the relative placement of the light source 100 and the optical system 180. The beam-steering capability greatly simplifies installation of adjustable luminaires and extends their utility. To further increase the value of these adjustable luminaires, it is desirable to make them as compact as possible for visual appeal and flexible installation.

The beam-steering optical system shown in FIG. 1 (like similar systems from other prior art) utilizes an optical system 180 that possesses overall radial symmetry to accommodate adjustable beam aiming in any direction. As a result, the optical system 180 must have an equal lateral extent in every direction, and further it may require additional free volume to accommodate in-plane movement of the optical system in any direction in order to achieve beam steering. As a result, when implemented in a lighting fixture, this design necessarily occupies a significant volume. What is needed is a design for a beam-steering adjustable luminaire that is as compact as possible with minimal wasted space.

### SUMMARY

A highly compact lighting fixture with adjustable beam aiming using planar beam-steering optics is described herein. For example, a luminaire module may include a light source located in a first plane and a truncated optical system having an optical axis. The truncated optical system is configured to focus and aim light from the light source to form an output beam. The module also controls a tilt angle of the output beam over a range of tilt angles by adjusting a position of the optical system relative to a position of the light source along a line in a plane perpendicular to the optical axis. The truncated optical system is designed to occupy a small volume while ensuring that substantially all of the light from the light source is aimed and focused over a predetermined range of tilt angles. A pan angle of the output beam can also be adjusted, such as by rotating the luminaire module. Tilt and/or pan may be manual or motorized and controlled by a control system. Multiple such luminaire modules may be combined.

More particularly, the techniques described herein relate to a luminaire module that includes at least a light source disposed in a first plane, and a truncated optical system having an optical axis. The truncated optical system is configured to focus and aim light from the light source to form an output beam. The luminaire is further configured to control a tilt angle of the output beam over a range of tilt angles by adjusting the position of the optical system relative to the light source in a plane perpendicular to the optical axis. The truncated optical system is designed to occupy a small volume (enabling a small size for the entire luminaire module), while still ensuring that substantially all of the light from the light source is aimed and focused over a predetermined range of tilt angles.

In some embodiments, a tilt actuator may be provided to adjust the position of the optical system relative to the position of the light source along a line in the plane perpendicular to the optical axis. A pan actuator can also be configured to adjust a pan angle of the output beam. The pan actuator may rotate the entire luminaire module, including both the light source and the truncated optical system. In other embodiments, the pan actuator rotates the optical system independently of the luminaire module, about an axis that is parallel to the optical axis and passes adjacent a center of the light source.

The tilt and/or pan actuator may be manually operated, or may be motorized and controlled by a control system.

In some embodiments, the optical system further includes a solid optic and a conformal reflector. The conformal reflector may be a separate element from the solid optic. The conformal reflector and the solid optic may include lenslets.

A beam width actuator may rotate the conformal reflector relative to the solid optic around the optical axis, thereby providing adjustment of a width of the output beam.

In other aspects, the solid optic includes a stationary slab and a moving component.

A luminaire may include multiple luminaire modules, each module including a light source in a first plane and a truncated optical system with an optical axis wherein the optical system focuses and aims the light from the light source to form a beam, and the tilt angle is controlled over a range of angles by adjustment of the position of the optical system relative to the light source in the plane perpendicular to the optical axis, and where the spatial extent of the optical system is constrained to the minimum dimensions required in order to focus and aim substantially all of the light from the light source over a specific designed range of tilt angles for the output beam.

In a case where the luminaire includes two modules, one may be facing upwards and one facing downwards, such as in a sconce-type fixture.

The luminaire may include multiple modules in an array, each of which produces a beam that may be independently aimed. Or in other aspects, the modules may be linked so that all produce beams that are aimed in a common direction.

### BRIEF DESCRIPTION OF THE DRAWINGS

These and other aspects of the luminaire and modules are evident from the followed detailed description and the accompanying drawings, where:

FIG. 1 shows a cross-section view of a beam-steering optical system of prior art.

FIG. 2 shows a cross-section view of a truncated beam-steering optical system.

FIGS. 3A and 3B show two views of an exemplary embodiment of a truncated optical system and light source, aligned to produce a beam with zero tilt. FIG. 3A shows a cross-section view and FIG. 3B shows an angled view.

FIGS. 4A and 4B show two views of an exemplary embodiment of a truncated optical system and light source, aligned to produce a beam aimed at a tilt angle. FIG. 4A shows a cross-section view and FIG. 4B shows an angled view.

FIGS. 5A-5C show a simplified schematic of a compact adjustable luminaire. FIGS. 5A and 5B show adjustment of tilt, and FIG. 5C shows adjustment of pan by rotation of the housing.

FIGS. 6A-6C show a simplified schematic of a compact adjustable luminaire. FIGS. 6A and 6B show adjustment of tilt, and FIG. 6C shows adjustment of pan by rotation of the optical system.

FIG. 7A is a cutaway perspective view of the internal mechanical components of an example compact adjustable luminaire, showing a scroll-wheel affordance for adjustment of beam tilt angle by sliding the optical system.

FIG. 7B shows the external view of an example compact adjustable luminaire with a scroll-wheel affordance for adjustment of beam tilt angle.

FIGS. 8A-8D show alternative embodiments of the truncated optical system. FIG. 8A shows a truncated hollow reflector, FIG. 8B shows a truncated refractive lens, FIG. 8C shows a truncated optical system with textured lens and FSR allowing for lenticular beam broadening, FIG. 8D shows a truncated optical system in which the lens is comprised of a fixed, stationary slab and a moving component such as sliding lens cap.

FIG. 9 shows an embodiment in which the optical system is slightly tilted relative to the axis of motion.

FIGS. 10A-10D show embodiments of luminaire products using compact adjustable modules. FIG. 10A shows a single adjustable downlight, FIG. 10B shows multiple adjustable modules in a single luminaire, FIG. 10C shows adjustable modules in a wall sconce, FIG. 10D shows an adjustable module embedded in a bollard for use in path lighting.

FIG. 11 shows the use of multiple optical systems with specific orientations to produce a complex aggregate beam pattern.

### DETAILED DESCRIPTION OF PREFERRED EMBODIMENTS

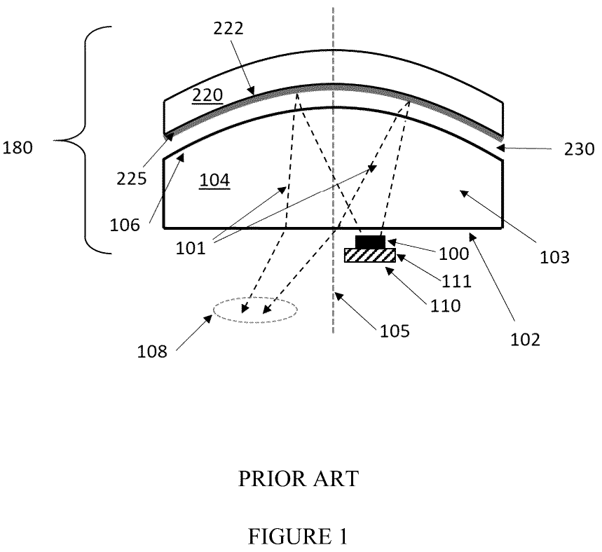

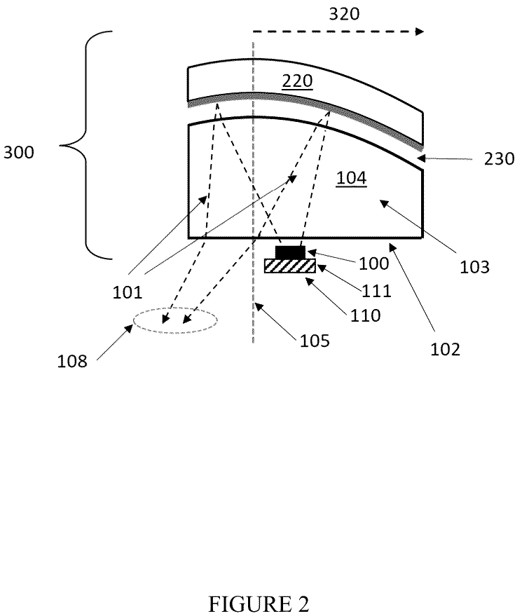

FIG. 2 shows a truncated optical system 300. It retains the elements of FIG. 1 but is designed to accommodate only a limited steering range. In the example of FIG. 2, the optical system is designed to accommodate steering only in a single direction, so that the output beam may be aimed relative to the optical axis 105 over a predetermined range from 0° to a maximum steering angle (for example, 45°) in a single direction along axis 320. Put in conventional aiming terms, this optical system accommodates a range of tilt adjustment in a single pan direction. The tilt adjustment range corresponds to a limited range of in-plane displacements of the optical axis 105 relative to the light source 100 that varies from zero to some fixed, predetermined amount along direction 320. These displacements may be implemented by an actuator of some type,

The optical system 300 accommodates the light cone 101 from light source 100 when optical axis 105 is located at any displacement in this predetermined range of displacements. The light cone 101 to be accommodated might be defined as the volume in which 90% of the light from light source 100 is contained. The truncated optical system 300 is then defined by determining the volume of lens 104 and the surface of reflector 220 that fall within light cone 101 for every position of the optical axis 105 relative to the light source 100 in the range of displacements. Any volume of lens 104 or reflector 220 that does not fall within the light cone 101 for any of these positions may be removed in order to reduce the dimension of the truncated optical system 300. For this reason it is called a “truncated” optical system. The optical system is not symmetric about the optical axis as would be required to accommodate tilt steering in any pan direction; instead, it can be made much smaller which in turn enables a much smaller overall size of the luminaire module. The truncated optical system is asymmetric about its optical axis.

The desired steering range may be defined in various ways. It may be restricted to a range of tilt angles in a single pan direction along 320 as shown in FIG. 2, it may include some limited steering in the opposite pan direction, or it may include some limited range of adjustment for both pan and tilt. In all cases, the optical system may be truncated to achieve a minimum size while accommodating the light cone from the entire desired adjustment range.

The light cone from light source 100 may be defined in various ways. It may be defined to include a certain fraction of the light emanating from source 100, or a certain fraction of the light emanating from source 100 that enters solid optic 104. The fraction is preferably set at a high value such as 90%, 95% or 99% in order to ensure high system efficiency.

Alternatively, the dimensions of the truncated optic may be adjusted empirically to ensure the output beam maintains a certain light quantity without calculating the precise contours of the light cone within the optical system.

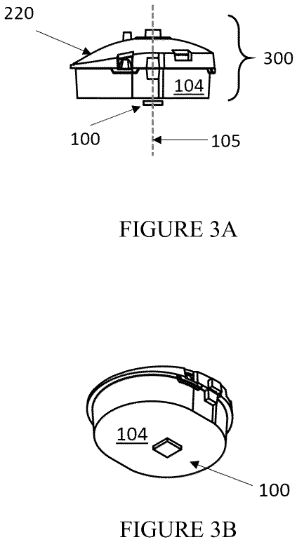

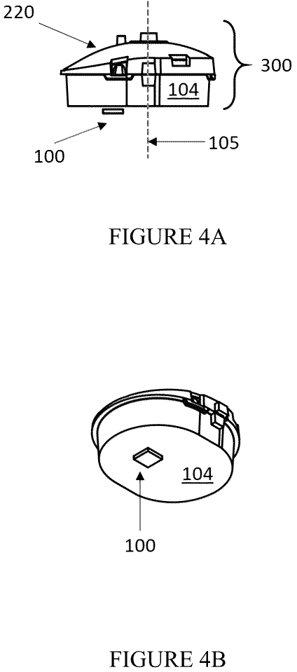

FIGS. 3A and 3B show various views of an exemplary truncated optical system 300 with light source 100. In FIG. 3A the optical axis 105 is centered on the light source 100 so the tilt of the light beam 108 is zero. FIGS. 4A and 4B show various views of the same system with the optical system 300 displaced along direction 320 so that the optical axis 105 is no longer aligned with light source 100.

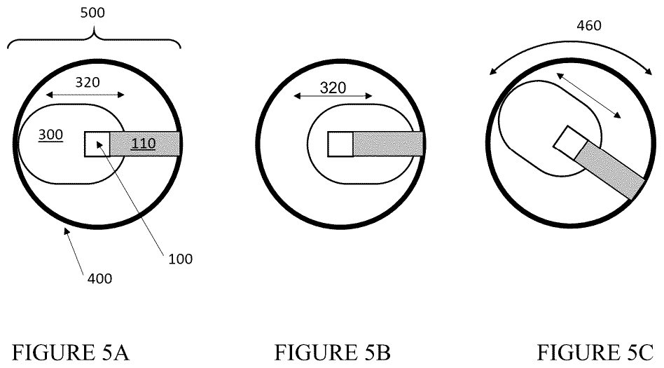

FIGS. 5A, 5B and 5C show an adjustable luminaire based on the optical system of FIG. 2. The light beam from the luminaire may be adjusted in any direction. FIGS. 5A and 5B show the mechanism for adjusting tilt aiming of the light beam by adjusting the position of optical system 300 to change the location of optical axis 105 relative to the light source 100 along direction 320. Light source 100 is attached to housing 400 by support element 110. Optical system 300 is also attached to the housing 400 via a mechanism (not shown) that permits it to slide in-plane in order to adjust the tilt aiming of the output beam. FIG. 5C shows that housing 400 may be rotated along direction 460 to adjust the pan of the output light beam by changing the orientation of direction 320 relative to the outside world. By separately controlling the tilt and the pan of the output beam, the output beam may be aimed in any direction up to the maximum tilt angle. The overall dimension of the luminaire is minimized by truncating the optic so that it accommodates tilt in one direction only, and using rotation of the luminaire housing to adjust pan.

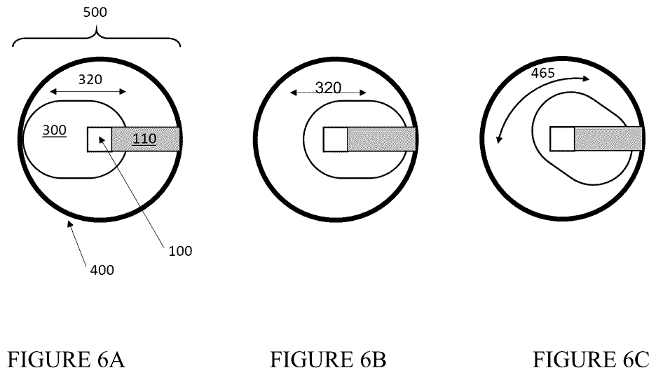

FIGS. 6A, 6B and 6C show an alternate embodiment of an adjustable luminaire based on the optical system of FIG. 2. In this embodiment, the housing 400 is not rotated but is held in a fixed orientation. Light source 100 is attached to housing 400 and is similarly held fixed. FIGS. 6A and 6B show that tilt adjustment is achieved by adjusting along axis 320 as in previous embodiments. FIG. 6C shows that optical system 300 may be rotated along axis 465 around the location of light source 100 in order to adjust pan of the output beam, by changing the direction 320 of tilt adjustment.

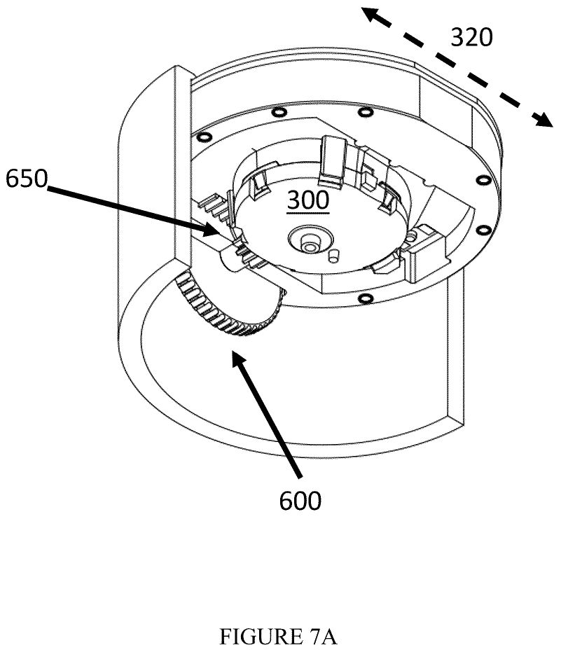

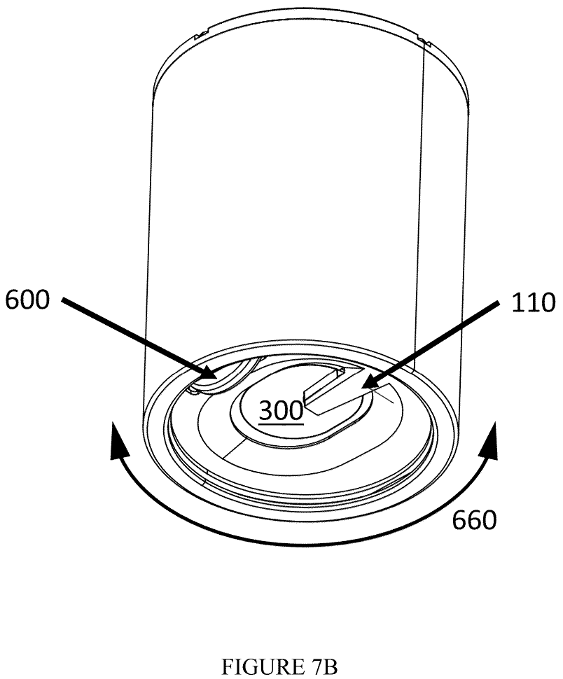

Various user affordances are possible for controlling the tilt adjustment. FIG. 7A is an internal cutaway view of a luminaire showing the use of a tilt actuator, such as a scroll-wheel 600, connected to a manually operated rack-and-pinion mechanism 650 to move optical system 300 back and forth along direction 320. FIG. 7B shows an external view of the luminaire featuring the scroll wheel tilt adjuster 600. The pan adjustment is affected in this example by a mechanism that is capable of rotating the entire fixture in directions 660.

Other types of actuators for adjusting the tilt aiming of the beam could include a lever or joystick, a sliding tab, a dial or screw drive, or a motorized drive connected to a control system. In all cases, to ensure smooth linear motion of optical system 300, a rail system or similar mechanism may also be employed. Actuators for pan adjustment could include a dial or screw driven rotation, a protruding handle (which may optionally be removable), a motorized drive, or simply a grip ring around the luminaire circumference. Many other mechanical designs and affordances for the tilt and/or pan adjustment are possible.

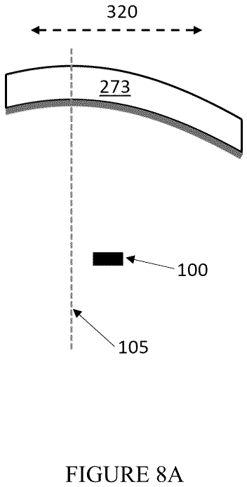

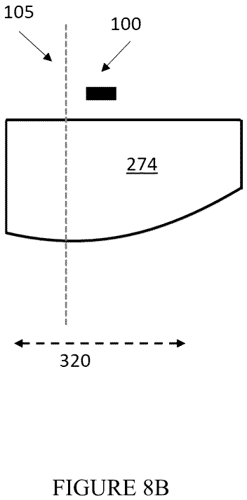

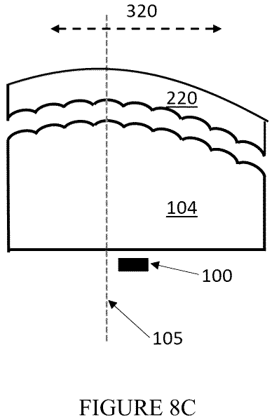

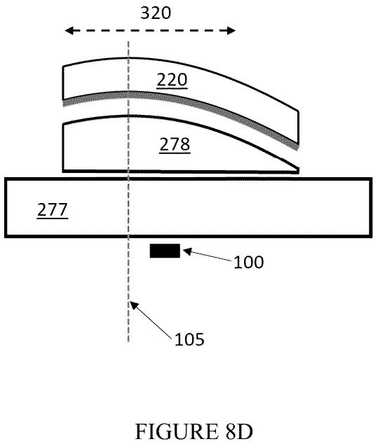

FIGS. 8A-8D show various alternative truncated optical system designs that can provide in-plane beam steering. FIG. 8A shows an optical system comprised of a hollow reflector 273. FIG. 8B shows an optical system comprised of a refractive lens 274. FIG. 8C shows an optical system comprised of a solid lens and a FSR where both the FSR and the lens are textured and the FSR may be rotated around optical axis 105 in order to adjust the width of the output beam via lenticular beam broadening. FIG. 8D shows an optical system comprised of a solid lens and FSR, wherein the solid lens is comprised of a fixed slab 277 and a sliding lens cap 278. Any of these embodiments, or other embodiments of planar beam-steering optics, may be truncated according to the principles described herein and used as the optical system to create a compact adjustable luminaire.

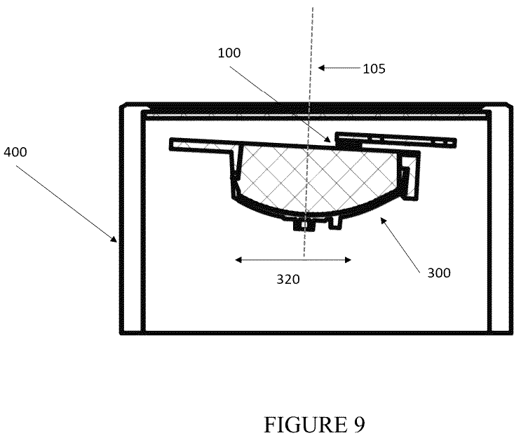

In some instances, it may be desirable to manufacture the luminaire with a slight fixed tilt of the plane of motion of the optical system 300 so that the optical axis 105 is not precisely perpendicular to the output face of the luminaire. FIG. 9 shows such an embodiment. Tilting the optical system 300 in this way allows the output beam to exit the luminaire closer to the front surface of the lighting fixture when steered at maximum tilt, which allows the housing to be made smaller without clipping light from the highly-steered beam.

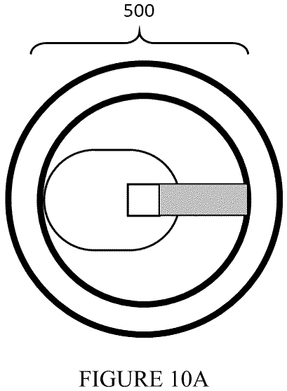

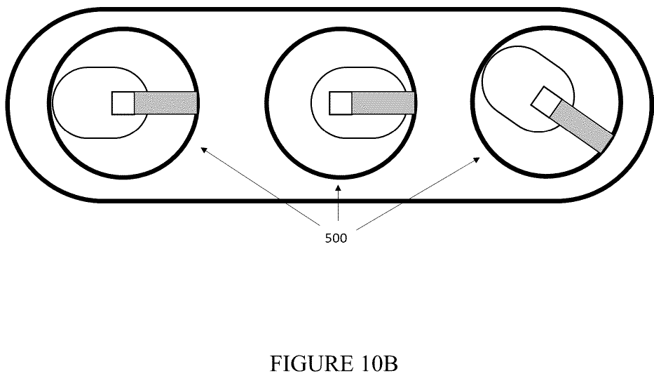

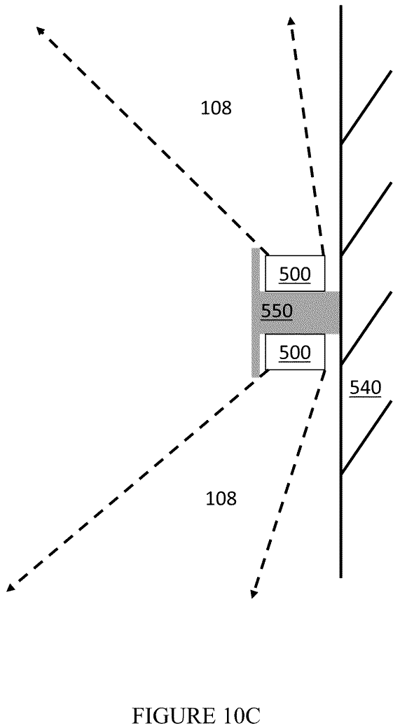

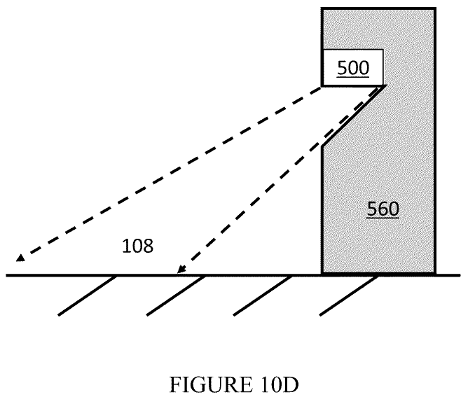

FIGS. 10A-10D show various embodiments of luminaires using the designs described here in. Each embodiment employs one or more lighting module 500, and each lighting module 500 comprises a light source 100, a truncated optical system 300 with sliding adjustment of beam tilt, a rotational mechanism for beam pan, and user affordances for adjusting the beam tilt and pan. FIG. 10A shows a single module 500 employed as a compact ceiling-mounted adjustable downlight. FIG. 10B shows multiple modules 500 combined into a single lighting fixture. The individual modules may be independently adjustable, or may be configured so that they all are adjusted to the same aiming angle via a mechanical linkage or electronic control. FIG. 10C shows a sconce fixture 550 mounted on a wall 540, with independently adjustable modules 500 aimed upward and downward for illumination of the ceiling and floor respectively. FIG. 10D shows a module 500 mounted in a bollard 560 to serve as a path light. Additional embodiments not shown include integration into furniture, handrails, and more.

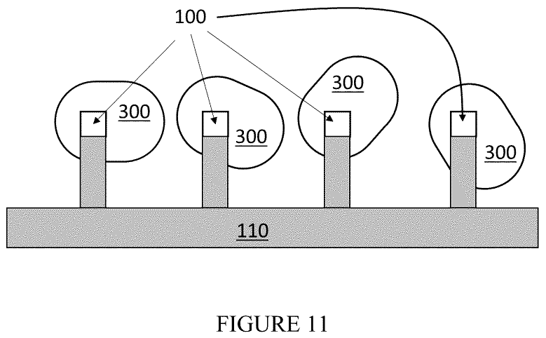

FIG. 11 shows the use of the optical systems described herein to create a luminaire with a specific desired beam pattern. The luminaire comprises an array of one or more optical systems 300 where each optical system is mounted in a specific configurations relative to a corresponding light source 100 to create an individual beam aimed in a specific direction. The aggregate beam pattern from the luminaire is the sum of the output beams from each of the optical systems. The optical systems 300 may be fixed in place during manufacturing to create a fixed beam aggregate beam pattern, or they may be provided with some adjustability to allow adjustment of the beam pattern.

These examples are not exhaustive, and other useful implementations of these designs within lighting systems will be evident to those skilled in the art.

1. A luminaire module comprising:
a light source disposed in a first plane; and
a truncated optical system with an optical axis;
wherein
the truncated optical system is configured to focus and aim light from the light source to form an output beam;
a positioning mechanism is configured to control a tilt angle of the output beam over a predetermined range of tilt angles by adjustment of a position of the optical system relative to a position of the light source in a plane perpendicular to the optical axis; and
the optical system is asymmetric about the optical axis and further configured to focus and aim substantially all of the light from the light source over the predetermined range of tilt angles for the output beam.

2. The luminaire module of claim 1 further comprising:
a tilt actuator configured to adjust the position of the optical system relative to the position of the light source along a line in the plane perpendicular to the optical axis, thereby adjusting the tilt angle of the output beam.

3. The luminaire module of claim 1 further comprising:
a pan actuator configured to adjust a pan angle of the output beam.

4. The luminaire module of claim 3 in which the pan actuator rotates the entire luminaire module, including both the light source and the truncated optical system.

5. The luminaire module of claim 3 in which the pan actuator rotates the optical system about an axis that is parallel to the optical axis and passes adjacent a center of the light source.

6. The luminaire module of claim 2 in which the tilt actuator is manual.

7. The luminaire module of claim 3 in which the pan actuator is manual.

8. The luminaire module of claim 2 in which the tilt actuator is motorized and controlled by a control system.

9. The luminaire module of claim 3 in which the pan actuator is motorized and controlled by a control system.

10. The luminaire module of claim 1 in which the optical system further comprises a solid optic and a conformal reflector.

11. The luminaire module of claim 10 in which the conformal reflector is a separate element from the solid optic.

12. The luminaire module of claim 11 in which the conformal reflector and the solid optic both comprise lenslets, and the luminaire module further comprises:
a beam width actuator, configured to rotate the conformal reflector relative to the solid optic around the optical axis, thereby providing adjustment of a width of the output beam.

13. The luminaire module of claim 10 in which the solid optic comprises a stationary slab and a moving component.

14. The luminaire module of claim 10 in which the light source and optical system are angled relative to an output face of the luminaire.

15. The luminaire module of claim 1 wherein a spatial extent of the optical system is constrained to minimum dimensions required to focus and aim substantially all of the light from the light source over the predetermined range of tilt angles for the output beam.

16. A luminaire comprising multiple luminaire modules, each module comprising a light source disposed in a first plane; and
a truncated optical system with an optical axis;
wherein each module is further such that:
the truncated optical system is configured to focus and aim light from the light source to form an output beam; and
a positioning mechanism is configured to control a tilt angle of the output beam over a predetermined range of tilt angles by adjustment of a position of the optical system relative to the light source in a plane perpendicular to the optical axis, and
the optical system is asymmetric about the optical axis and further configured to focus and aim substantially all of the light from the light source over the predetermined range of tilt angles for the output beam.

17. The luminaire of claim 16 comprising two modules, one facing upwards and one facing downwards, configured to be mounted on a wall as a sconce-type fixture.

18. The luminaire of claim 16 comprising multiple modules in an array, each of which produces an output beam that is independently aimable.

19. The luminaire of claim 18 comprising multiple modules in an array, each of which is linked to one or more other modules, so that all modules in the array produce beams that are aimed in a common direction.
